(19) United States
(12) Patent Application Publication
(10) Pub. No.: US 2023/0075920 A1
(43) Pub. Date: Mar. 9, 2023

(54) AUTOMATION OF THE MANUFACTURING OF ELECTRICAL PANELS THROUGH AN IDENTIFIED PROCESS

(71) Applicants: Renaud BOGAERT, La Louvière (BE); Vittorio AGOSTINI, Waterloo (BE); Pierre BOGAERT, Etterbeek (BE); Andrea OCCHILUPO, Bruxelles (BE)

(72) Inventors: Renaud BOGAERT, La Louvière (BE); Vittorio AGOSTINI, Waterloo (BE)

(21) Appl. No.: 17/795,750

(22) PCT Filed: Jan. 26, 2021
(86) PCT No.: PCT/EP2021/051749

§ 371 Date: Jul. 27, 2022

(30) Foreign Application Priority Data
Jan. 29, 2020 (EP) 20154385.7

(51) Int. Cl. H02B 1/04

(52) U.S. Cl. CPC H02B 1/04

(57) ABSTRACT

The present invention relates to the field of electrical installations, and in particular to the automation of the manufacturing of electrical panels adapted to their environment. The components of the electrical panels of the invention are organised in separated boxes depending on whether they are supplied with high power or low power. The components are selected and organised according to their function and the family of equipment that they manage or power, in an identifiable way. This simplifies the maintenance work of the panel, and can be safely carried out even by an unqualified operator.

The present invention relates to the field of electrical installations, and in particular to the automation of the manufacturing of electrical panels adapted to their environment.

A traditional electrical panel includes a range of electrical components, in line, without any particular logic for controlling the functioning of all the different equipment in an electrical installation, irrespective of their distance from the panel.

Equipment refers to a device or a set of devices of the same type intended to be connected to the electrical grid, for example a set of lamps (lighting equipment), a radiator or a set of radiators, a water heater, an industrial machine, an oven, a cold room, etc., possibly attached to a specific room (lightings in a room).

Electrical components refer to all the components forming the interface between the electrical grid and the equipment, such as circuit breakers, safety systems, micro-controlled management units like programmable logic controllers, input-outputs interfaces, etc. These components can be categorised into two major purposes, or functions: management and power, well known to persons skilled in the art.

Management refers, in a circuit diagram, to the part which is used to give commands, possibly on the basis of feedback from certain sensors or probes. It allows, for instance, the power source to be activated or switched off. This part particularly includes the control, regulation, metering systems which allow actuators and other parts to be controlled.

Power refers, in a circuit diagram, to the part which allows the power to be channelled towards the electrical load. It also comprises safety and variance functions.

Thus, this management and power centralisation requires a multitude of significantly long cables to connect the panel to the equipment, or to their earthed components. This complicates the installation, bringing all the electrical components together in the same place and making the identification of a problem or the maintenance of a specific component difficult.

Additionally, the numerous long cables required for a traditional electrical installation are excessively expensive, and lead to unnecessary energy losses proportional to the length and the number of cables.

Furthermore, a traditional electrical panel is designed to include 25% of free space for possibly adding other components later. This drastically limits its flexibility in cases where the electrical installation needs to be expanded.

Finally, the traditional electrical panels are designed to be flat (or two dimensional), resulting in an additional loss of space. Flat refers to the fact that each component is next to another, one, that all wires are connected from the back of the panel, and that the latter's depth is never used.

In order to mitigate these problems, the applicant has deemed it necessary to propose an electrical panel, and a method for manufacturing and installing it, making it possible to reduce the length required for cables, simplify the electrical installation, facilitate the maintenance work of various trades, save space, and consequently reduce installation costs and energy consumption.

### Solution of the Invention

To this end, the invention relates to an electrical panel for connecting at least one equipment to an electrical grid comprising:
a power box comprising at least one electrical component that transports electricity to the equipment,
if required, a management box comprising at least one electrical component that transports an information signal, and
at least one junction box comprising ports that connect the equipment to the components of the panel corresponding to it.

Preferably, the power box is remote or separate from the management box, that is to say that there is space between the two.

Box refers to a module, a section or a part of the electrical panel distinctly separated from the other modules, sections, or parts, and comprising one or more components linked to a specific function. A box is a case, preferably reclosable by a cover plate, containing a bridge on which one or several electrical components can be fixed.

Unlike conventional electrical panels where all the components of a multitude of equipment are arranged in no particular order, the electrical panel of the invention seeks to introduce a wiring logic, which is much more intuitive.

Preferably, the panel comprises two junction boxes.

Electrical component transporting electricity to the equipment refers to a component designed to be involved in channelling the energy necessary for the functioning of the equipment, i.e. the power function, such as a power contactor or a power circuit breaker, etc.

The power box contains, for example, components functioning in the high power system (circuit breakers, safety system, etc.), the management box comprises, for example, components functioning in the low power system, such as control electronics), and the junction boxes comprise, for example, connection ports between one equipment and the components of the panel corresponding to it.

Here, control electronics particularly indicates micro-controlled management units (MMU) that can be called “communicating” (CMMU). This name can indicate Industrial Programmable Logic Controllers or PLC, or local management units or LMU. Control electronics can also refer to input-output interfaces, measurement systems, but is not limited to the area of activity, and can be applied to buildings, industries, infrastructures, etc.

High power refers to the power designed to transport electricity in the grid. In the electrical panel of the invention, this is the power transporting energy from the power supply upstream of the panel to the downstream equipment.

Low power refers to the power designed to transmit an information or control signal.

Electrical component transporting an information signal refers to a component designed to transmit an information or control signal, the content of which impacts the power control, i.e., a management function. This component is not directly linked to the transmission of electricity to the equipment, but is nonetheless a micro-controlled management unit, a control relay, etc. For example, the information signal comes from sensors such as temperature, humidity, and pressure probes, or external computerised controls, etc.

Preferably, the connection or junction ports are placed on a lateral side of the junction box in order to be easily accessible. Lateral side refers to a side which is neither the front side, generally reserved for the cover plate of the box, nor the rear side, which generally faces the wall on which the electrical panel is fixed.

Advantageously, the power and management boxes are separated by the junction boxes placed parallel to one another with connection ports facing a central space, granting easy access to the connection ports.

Preferably, the junction boxes are less deep than the other boxes so that the panel can be installed on a cable-tray passing behind them.

Preferably, the electrical components inside the boxes can be assembled next to one another, and also behind one another in the panel's depth to reduce the space taken up by the electrical panel. To this end, the electrical components can be assembled on a bridge to facilitate access during maintenance by a professional. In this case, the components can be placed on top of each other, back-to-back, and in staggered rows, such that the connection cables intertwine in a single bundle to optimise space.

Each electrical component in the panel can be identified, for example be labelled, with a text or a code, and/or be assigned a colour code. A colour code can also be assigned to cables and/or junction ports corresponding to each type of signal to incorporate the information in the panel. This makes the technician's work easier and reduces the risk of error.

The connection cables between boxes can be of a standard length to facilitate the connection of the electrical panel of the invention. Thus, the technician can bring pre-cut cables for the installation, and therefore will not have to cut them on site. Here, standard length means that a range of pre-cut cables of the same length, or a small number of identical lengths enables all the connections to be made in the panel. This standard length contradicts the current practice, wherein the operator needs to adjust the required length of the cable while joining each equipment.

The electrical panel can be pre-equipped before installation to facilitate its assembly and reduce the level of expertise required for its installation.

The boxes can be made of polycarbonate plastic to have better UV resistance and be transparent for an easier first-level diagnosis, of metal for better mechanical resistance (in this case, separating the boxes helps to avoid any magnetic interference, preventing the risk of malfunction), or of any other material deemed appropriate by the persons skilled in the art.

Preferably, the boxes are equipped with a hood providing resistance to shocks and/or rain, and protects the interior of the boxes from dust. More preferably, the hood of the box placed at the top of the electrical panel is deeper, such that it offers additional protection from the rain for the panel's base by forming a protrusion over the other boxes.

The invention also pertains to an electrical installation in a building comprising at least two electrical panels according to the invention. The panels can be connected following two connection principles: connection by “distributed driving force” (or DBDF), or connection by “direct driving force” (or DRDF). Distributed driving force refers to the fact that a single circuit breaker located upstream protects multiple panels joined in a series (one protection for one series of panels). Direct driving force refers to the fact that each panel joined as per this principle is protected by one circuit breaker (one protection per panel).

The use of the electrical panel of the invention in an electrical installation of a building is also claimed.

The invention additionally relates to a process to electrically connect an equipment, comprising the following steps:
the power functions of the equipment are connected to their components for transporting electricity that are located in a first power zone or power box of an electrical panel,
the management functions of the equipment are connected to their components for transmitting information or control signals that are located in a second management zone, or management box of the same electrical panel,
   the connections being made via at least one junction zone or box separated from the power and management zones.

Preferably, the electrical panel is located near the equipment.

Near refers to a distance shorter than 20 metres, preferably shorter than 15 metres, and more preferably shorter than 10 metres. The point of this proximity is to reduce the cable lengths required for the equipment installation, and to facilitate the identification of the electrical components of the equipment.

Furthermore, the invention pertains to a process to electrically join at least two equipment in a building, according to which the equipment are joined to multiple electrical panels according to the previous process.

Finally, the invention pertains to a method of manufacturing an electrical panel to connect the equipment of an installation, the electrical panel comprising at least one power box, one management box, and one junction box, comprising the following steps:
the technical information required for connecting the electrical panel to the installation is determined,
the equipment to be connected to the electrical panel are identified and categorised by family according to a nomenclature of family, determined on the basis of the installation type, to establish a list of families of equipment to be connected,
the management functions (or purposes) of the equipment associated with each family from the list of families are identified to establish a list of functions to be connected,
each management function is set up in an organised way in a management box of the electrical panel,
the components for transporting electricity to the equipment, required for connecting the equipment are determined and installed in a power box of the electrical panel,
the adapted electrical connections between the management functions, the components for transporting electricity to the equipment and the junction ports included in the junction box are established.

In the application, the term “join” or “joining” is equivalent to connect or connecting, and usually refers to an electrical connection.

The technical information required for joining the electrical panel to the installation comprises, for example, the available type of power supply, the panel's location, the particular technical specifications requested by the client or rendered necessary by the location of the building, the standards in force, etc.

Advantageously, the management functions (or purposes) of the equipment linked to each family from the list of families are identified according to a nomenclature of functions determined for each family, to establish a list of functions to be joined.

More advantageously, each management function is set up in an organised way in a management box of the electrical panel such that it forms modules, each module corresponding to a function of a family.

The electrical panel of the invention as well as the method of manufacturing and joining the panels according to the invention helps to arrange the electrical installation such that it saves 40 to 60% of cable. This also helps to simplify the electrical installation and make it much more intuitive, to facilitate the maintenance work of a professional by allowing him/her to easily identify the electrical panel corresponding to his/her trade, or even to be able to expand the installation without restrictions and without necessarily having to cut the general power supply to avoid any risk of electrocution.

Furthermore, the separation between the power and management boxes allows the components functioning in the high power system to be isolated from the components functioning in the low power system, placed in the power and management boxes respectively. Thus, this allows the persons skilled in the art, during the maintenance work of the panel, to be sure of differentiating the part of the panel that is directly electrically dangerous (i.e. the part in the high power system where the high currents, and potentially, high voltages (for example, low voltages, between 50 and 1000 VAC, and between 120 and 1500 VDC) can lead to electrocution, causing severe injury or death) from the part where the current is no longer directly fatal to a human (i.e. the low power system, where we also potentially find lower voltages, for example very low voltages below 50 VAC or 120 VDC).

The invention will be better understood with the help of the following description of an embodiment of the invention, with reference to the appendix of figures, in which:

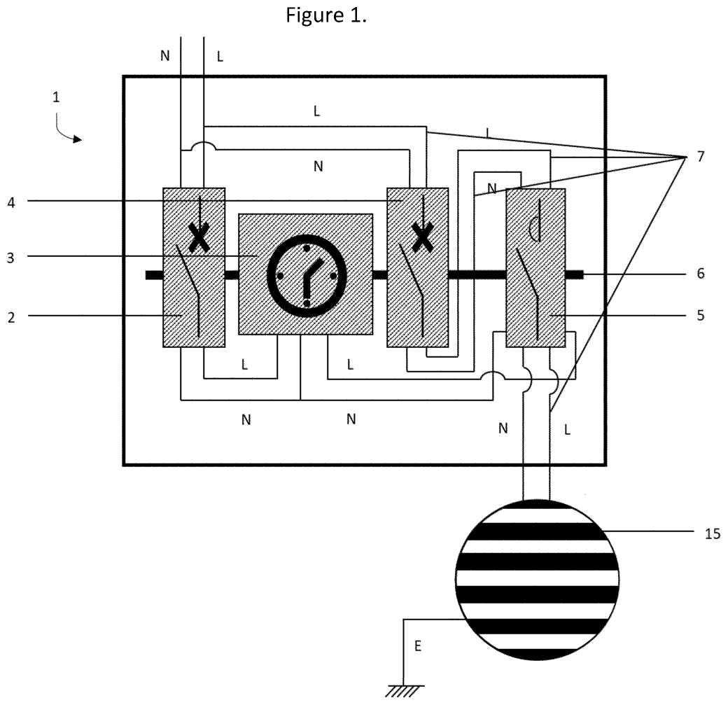

FIG. 1 is a diagram of an electrical panel of the prior art for controlling a water-heater,

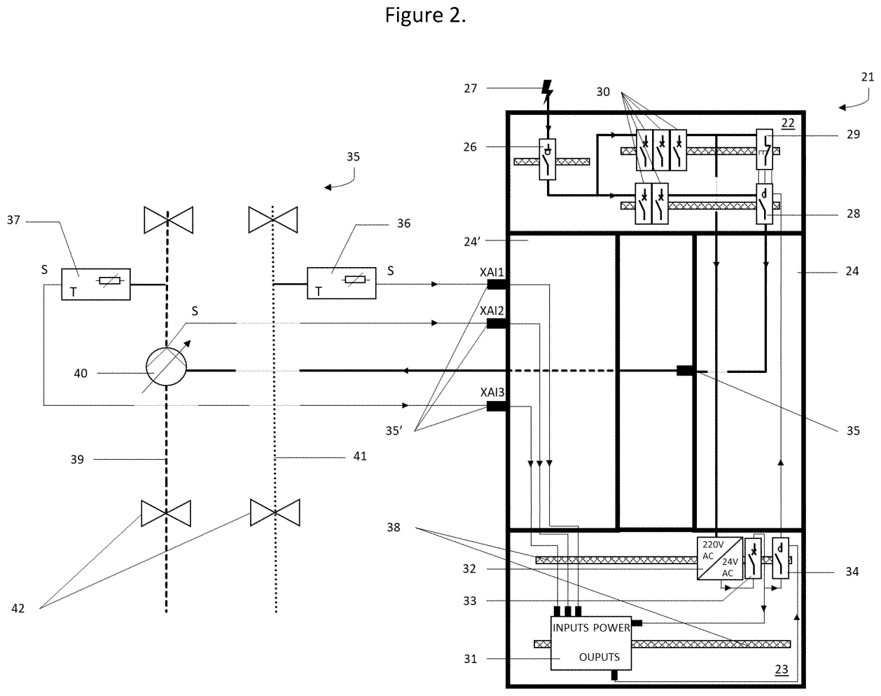

FIG. 2 is a diagram of an electrical panel according to the invention for controlling a heating circuit,

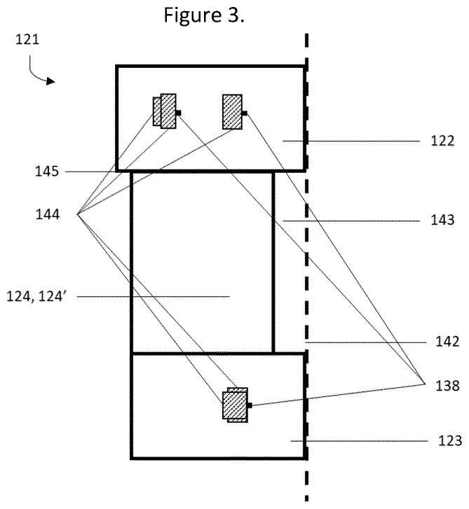

FIG. 3 illustrates the right-side view of the electrical panel of FIG. 2,

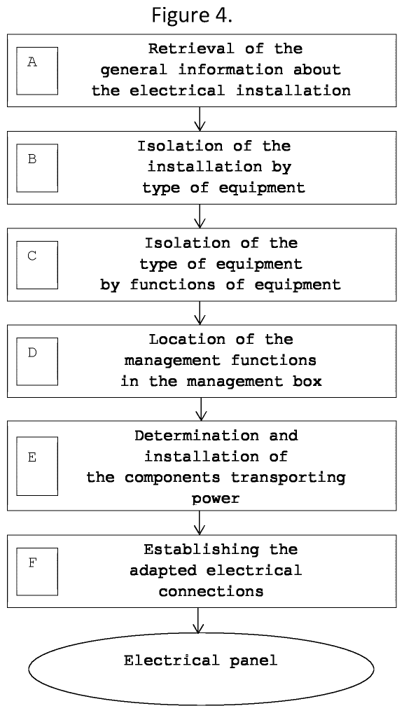

FIG. 4 illustrates the manufacturing process of an electrical panel according to the invention,

The equipment can be classified by families, and by function according to a defined nomenclature. Each family can, for instance, be associated with a specific corporation or have a common technical objective, whereas the functions include the equipment or group of equipment having a specific functioning more precisely. For example, the table below illustrates the types and functions in a building.

| | |
|---|---|
| 1. Heat production | 1. Boiler(s) |
| | 2. Heat Pump (HP) |
| | 3. Co-generation |
| | 4. Geothermal |
| | 5. Solar panels |
| | 6. Urban production |
| | 7. Heat collector with pump |
| | 8. Heat collector with pressure |
| | breaker cylinder |
| 2. Heating | 1. Heating circuits |
| circuits | |
| 3. Domestic hot | 1. Single-energy |
| water | 2. Bi-energy |
| | 3. Multi-energy |
| 4. Cold production | 1. Monoblock cooling system |
| | 2. Cooling system with dry |
| | cooler |
| | 3. Cooling system with open |
| | cooling tower |
| | 4. Cooling system with closed |
| | cooling tower |
| | 5. Cooling system with hybrid |
| | tower |
| | 6. Cold collector with pump |
| 5. Cooling | 1. Cooling circuits |
| circuits | |
| 6. Air handling | 1. Complete recycling |
| | 2. Partial recycling |
| | 3. Supply System (SS) partial |
| | recycling |
| | 4. Extraction System (ES) |
| | partial recycling |
| | 5. Fresh air |
| | 6. Miscellaneous |
| 7. Automation of | 1. Fan coil unit |
| the room | 2. Radiators |
| | 3. Cooling ceiling |
| | 4. Air handling |
| | 4.1 Constant-variable air |
| | volume (CAV-VAV) |
| | 4.2 Convector |
| | 5. Air duct heater |
| 8. Miscellaneous | 1. Variable recovery (single |
| | line) |
| | 2. Meter readings (electricity, |
| | energy)-Electric pulse |
| | 3. Variable recovery (with |
| | communication protocol) |
| | 3.1 Modbus interface |
| | 3.3 Bacnet/MSTP integration |
| | 3.4 Bacnet/IP integration |
| | 3.5 OPC interface |
| | 3.6 Other interface |
| 9. Centralised | 1. Online |
| Technical | 2. Centralised Technical |
| Management (CTM) | Management (CTM) |
| | 3. Nil |
| | 4. Miscellaneous |

Panel 1

In reference to FIG. 1, an electrical panel 1 of the prior art for controlling a water heater 15 comprises a 2-amp circuit breaker 2 for protecting a programmer 3, a 20-amp power circuit breaker 4, a 20-amp power contactor 5, as well as a bridge 6 enabling all of the above electrical components 2, 3, 4, and 5 to be fixed in the panel 1. All the electrical components 2, 3, 4, 5 are joined by a set of cables 7. The power supply (not shown) of the panel components is also enabled through cables 7, made up of a phase cable, or line (L) and a neutral cable (N), and the water heater is earthed by a cable E. The components are joined such that:
the 2-amp protection circuit breaker 2 protects the programmer 3 from an electrical overload, while ensuring that it is directly powered from the external power supply;
the power circuit breaker 4 protects the power contactor 5 from an electrical overload, while ensuring that it is directly powered from the external power supply;
the programmer 3 controls the switching of the power contactor 5 in order to allow, or not allow, the current to flow from the power circuit breaker 4 to the water heater 15.

The electrical panel 1 of the prior art has several drawbacks; on the one hand, all the electrical components are arranged one after the other without any particular logic, and without differentiation between the management and power components, making technical maintenance work complicated and risky. On the other hand, the management components are not grouped by function, and therefore cannot be easily identified by the different trades. Finally, the panel is not generally displayed in an intuitive way, that is to say that it is difficult to identify each component, input-output terminal, cable, etc. which makes its assembly and any possible future maintenance work complicated, and requires a high qualification level.

In reference to FIG. 2, an electrical panel 21 according to the invention for controlling a hydraulic pump 40 in a heating circuit 35 comprises a power box 22 located at the top of the panel, a management box 23 located at the bottom of the panel, two junction boxes 24 and 24′ located to the right and left of the panel respectively, between the control box 22 and the management box 23.

The power box 22 comprises a voltage disconnector 26 powered from the top of the box via an external power supply 27 (in this case, domestic 220V AC). The external power supply may be of any type known to the persons skilled in the art, including, for example, the three-phase 3×400V, the single-phase 230V, the single-phase 110V, etc. and can enter the box from any side. The power box 22 further comprises a power contactor 28 enabling it to channel, or not channel, the power to the pump 40 (controlled by a CMMU 31, principle explained below), a thermal relay 29 in order to cut off the power supply of the contactor 28 in case of heating, and a set of earth leakage switches/circuit breakers 30 protecting the installation and people from the risk of overvoltage and electrocution.

The management box comprises a micro-controlled management unit (CMMU) 31, which here receives its power supply (“POWER” interface) at 24 VAC from a transformer 32, here from 220 VAC to 24 VAC. The supply for the CMMU first passes through a circuit breaker 33 protecting the CMMU from overvoltage. The transformer 32 itself is powered by the power box 22. The transformer 32 and the circuit breaker 33 could also be placed in the power box 22, but in this case they are in the management box near the CMMU for accurate reading. The CMMU 31 comprises a set of input-output interfaces. Here, three analog inputs and one digital output are shown. Each CMMU (and adjacent components) or module required in the panel corresponds to a function (here, a single function: the heating circuit). Function refers to the term previously described in the middle of page 10, and exemplified by table no. 1.

The CMMUs used are of brands and models well known to the persons skilled in the art, and are standardised for each function. That is to say that depending on the equipment to be joined, some inputs-outputs may not be joined. This enables the persons skilled in the art to always work with the same modules, and contributes to making the electrical panel more intuitive.

The input interfaces of the CMMU 31 are connected respectively to the terminals 35′ in the junction box 24′ attached to the management part of the panel. The terminals 35′ are connected to a water inlet temperature probe 36, and a water outlet temperature probe 37, for which the CMMU 31 receives information feedback S as an analog signal. The terminals 35′ can be labelled (here XAI1, XAI2, and XAI3 for terminal block X, analog input 1, 2, and 3) and have colours corresponding to their function to make their connection more intuitive. The probe power connections are not shown for the sake of clarity, but are evident to persons skilled in the art.

Depending on the information feedback S, the CMMU 31 sends a digital signal, via a digital output, to a relay 34, so that it allows, or does not allow, the 24 VAC signal to pass from the transformer 32 to the contactor 28 located in the power box, so that the latter in turn powers (220 VAC), or does not power, the pump 40 via a terminal 35 located in the junction box 24. Here, all the components of all the panel boxes are mounted on bridges 38. For the sake of clarity, the installation has not been shown with all of the information feedback signals to the CMMU or the control and power supply signals of the equipment devices. It is, for example, possible for the valves 42 at the input and output of the heating circuit 35 to be controlled by the CMMU. Similarly, it is also possible for the information signals about the status of the contactor 28 and thermal relay 29 to return to the CMMU.

In operation, the water outlet and inlet temperature probes 36 and 37 indicate to the CMMU 31 the temperature of hot water 39 at the input and of cold water 41 at the output of the heating circuit 35. On the basis of this information, the CMMU 31 determines according to its internal programming whether the pump 40 should be activated or deactivated, and if necessary, sends a signal to the power contactor 28 so that the latter switches and respectively transmits or cuts off the power inflow to the pump 40. Internal programming refers to the operation requirements of the heating circuit 35 retransmitted in the form of a computer program uploaded to the CMMU, for example, from a centralised control station. Thus, the inflow of heat in the heating circuit 35 via the pump 40 is managed by the panel according to the invention.

The shown electrical components are not exhaustive and may not be present, may be present in an implementation, or in a different number, depending on the necessary functions. Here, only the “heating circuit” function was shown, but other functions could also be found in the panel. On this basis, there are different panel models that can be grouped into single-function or multi-function panels. In a multi-function panel, for example, we could find the control of a second heating circuit for which a second CMMU might be added in the management box 23, attached to other “high power” and “low power” components, and which would help to control this second heating circuit.

Furthermore, it is possible that some specific electrical components, assumed to be managing the power, may be located in the management box, or vice versa, as long as the high power system is in the power box and the low power system in the management box.

Additionally, the placement of the boxes and electrical components inside them may vary depending on the installation. For example, it is possible that the junction boxes 24 and 24′ are placed at the top and bottom of the panel, while the power 22 and management 23 boxes are placed to the left and to the right of the panel. Similarly, the terminals 35 and 35′ can be independently placed on the inside of the panel (i.e. in the empty central zone located between the 4 boxes of the panel), or on the outside of the latter depending on the connection most convenient for the person skilled in the art.

Here, the connections between the terminals 35, 35′ and the CMMU 31 are each shown by a cable directly linking them. However, it is possible that the terminals 35 and 35′ are connected to an intermediate terminal block positioned (not shown here for the sake of clarity) on a bridge located in the corresponding junction chamber (24 and 24′ respectively) to make the panel manufacturing or installation easier and more intuitive.

In reference to FIG. 3, an electrical panel 121 according to the invention can be designed such that the junction boxes 124 and 124′ are less deep than the power 122 and management 123 boxes, so that the connection cables leaving the panel can pass through a space 143 created between the junction boxes 124, 124′ and a support 142 on which the panel 121 is placed (for example a wall). Similarly, the power box 122 of the panel can be designed to be even deeper than the management box to form a protrusion 145 and protect the junction boxes 124, 124′ and the management box 123 from bad weather. As illustrated in the power box 122, the electrical components 144 can also be assembled in the panel's depth, for example on different bridges 138 located at different depths, in addition to being able to be assembled next to each other on the same bridge. This allows the space to be optimised as much as possible and makes the installation more practical and meticulous.

In reference to FIGS. 2 and 4, the manufacturing method of the panel in FIG. 2 will now be explained.

First and foremost, in step A, we ask the client for general information concerning the electrical installation. For example, we ask for the installation's location (outdoors, cellar, electrical room, etc.), the available power supply (3×400V+N, single phase 220V, etc.), the installation's breaking capacity (6 KA, 25 KA, 36 kA, etc.), the desired panel material (metal, polycarbonate, etc.), the quality of the desired project (LEED or BREEAM certification, building classification, etc.), among other things.

In step B, the installation is virtually isolated for the first time while identifying and categorising the equipment in the installation into families of equipment to be joined. In the electrical installation of FIG. 2, only a “heating circuit” equipment 35 from the “heating circuits” family in the left column of the type-functions table no. 1 (nomenclature of families specific to the installation type) can be found.

In step C, the electrical installation is virtually isolated for the second time by identifying and categorising the equipment of each family by functions of the equipment to be joined. Once again, in the installation in FIG. 2, only a single “heating circuit” equipment 35 belonging to the “heating circuits” function in the right column of family-functions table no. 1 is shown (nomenclature of functions).

In step D, the components to be set up for each management function are selected and arranged as modules in an organised way in the management box of the electrical panel. Thus, in the panel of FIG. 2, the “heating circuits” function is set up as the CMMU 31 and its adjacent components (the circuit breaker 33, the transformer 32, and the relay 34) corresponding to a module/function.

In step E, the components transporting power (or electricity) to the equipment required for joining the equipment (particularly while respecting the safety standards in force) are determined, and then they are installed in the power box. In the panel in FIG. 2, the following were first determined and then installed: the circuit breaker 30, the thermal relay 29, the contactor 28, and the disconnector 26.

Finally, in the last step F, the adapted electrical connections (as previously explained in FIG. 2) between the management functions, the components transporting electricity to the equipment, and the connection terminals of the junction boxes are established.

All the steps for implementing the components and pre-wiring can be carried out in the workshop before bringing the electrical panel thus prepared on its connection site. This work can be highly automated on the basis of simple diagrams, and thus be entrusted to unqualified personnel. Therefore, the only task left on site is to carry out the final joining of the connection terminals, without having to intervene inside the panel.

Advantageously, steps A to E can be carried out with the help of software or a special application prior to the installation of the components. The software can be set up to propose components depending on the information provided by a user. For example, the software or the application can be combined with an interface asking questions to the user in a specific sequence, about the content of the electrical installation, the equipment to be connected, the distance between them, the metric data related to the installation plan, etc. The user can be offered a choice of components, for example a choice of brands or rates. The software or the application can be programmed to determine the diameter of the cables depending on the power to be managed, the best-suited type of driving force (DRDF and/or DBDF), the colours to be used for cables depending on the placement of the functions in the panel, the dimensions of the panel, and its arrangement, i.e. the distribution of the components in the boxes. The process can thus automatically lead to an outline of the electrical plan of the installation and/or an estimate for making the panel(s).

At the end of the computerised process, an operator can have the composition of the panel to be assembled, made to measure. The said operator does not need to have any specific electrical skills, and the assembly can be done industrially. In the same way that a driver can configure their vehicle by choosing from a multitude of options, a manufacturer can configure the electrical panel(s) of their installation and have them manufactured “in factory” or “in workshop” by an operator.

The invention was explained for an electrical panel exclusively managing a heating circuit in a building. However, the invention is not limited to managing one single equipment, function, or family, and can manage a far more complete installation on the same principle. Similarly, the panel isolating the electrical installation into families and functions of page 10 and 11 is given as an example and does not represent an absolute and exhaustive version of the possible isolation of a building's electrical installation. It is entirely possible to group families/functions differently, and add other families/functions. Finally, the invention is not limited to an electrical installation of a building, and it is possible to apply the same principle and electrical panel described here to all types of electrical installations.

The invention has been illustrated in a direct driving force (DRDF) diagram, that is to say that each panel comprises the safety components that allow it to trip (one protection per panel). This configuration is specifically for when the functions are located in a confined space, such as a technical room, an air handling unit, etc. The driving force of the functions is distributed directly to the field components. The safety signal and communication network are distributed within the electrical panel. This configuration allows to save up to 40% of cable length.

However, depending on the location of the panel(s), it is also possible to work with distributed driving force (DBDF), that is to say that a circuit breaker located upstream of several panels joined in series. This location is particularly suitable when the project allows the functions (power and management) near the field components to be decentralised. In this case, several decentralised single-function panels are protected by a main circuit breaker located in the master function of the network of functions. Each network of functions must comprise at least one decision-making CMMU in which the safety management elements and the schedule are installed, enabling communication between other networks of functions. The driving force, the safety signal, and the communication network are distributed serially. This configuration allows to further limit the cable length with respect to a traditional connection, the cable length being reduced generally to 3 m or less, which allows to save up to 60% of the cable.

The invention is thus not only related to the multi-function panels such as the ones described above, but also to single-function panels Such a panel generally only comprises three boxes: one power box, one management or control box, and one junction box.

This so-called single-function panel is placed as close as possible to the part to be managed. Generally, its composition is simple because it only manages one function, and can advantageously be supplied pre-equipped with all its components, properly electrically connected to each other and to the terminals of the junction box. The installer can thus place a series of pre-equipped panels as close as possible to the equipment or the circuit corresponding to the function to be managed.

1. Electrical panel (21) to connect at least one equipment (40) to an electrical grid comprising:
a power box (22; 122) comprising at least one electrical component (26, 28, 29, 30) for transporting electricity to the equipment,
if required, a management box (23; 123) comprising at least one electrical component (31, 32, 33) for transporting an information signal, and
at least one junction box (24, 24′; 124, 124′) comprising ports (35, 35′) connecting the equipment to the components of the panel corresponding to it.

2. Electrical panel according to claim 1, wherein the power box is separated from the management box.

3. Electrical panel according to one of claims 1 and 2, comprising two junction boxes (24, 24′).

4. Electrical panel according to one of claims 1 to 3, in which the connection ports are placed on a lateral side of the junction box.

5. Electrical panel according to one of claims 1 to 4, in which the junction boxes (124, 124′) are less deep than the other boxes such that the panel can be installed on a cable-tray passing behind (143) the junction boxes.

6. Electrical panel according to one of claims 1 to 5, in which the electrical components (144) are set up on one or several levels on top of one another in the depth of their boxes.

7. Electrical panel according to one of claims 1 to 6, wherein each electrical component in the panel is identified and/or a colour code is assigned to the connection ports.

8. Electrical panel according to one of claims 1 to 7, in which the boxes are equipped with a hood set up in the protrusion (145) to protect the boxes from shocks and/or rain.

9. Use of the electrical panel according to one of claims 1 to 7 in an electrical installation.

10. Process of electrically connecting an equipment to an electrical panel according to one of claims 1 to 8 comprising the following steps:
the power functions of the equipment are connected to their components for transporting electricity that are located in a first power zone of an electrical panel,
the management functions of the equipment are connected to their components for transmitting an information or control signal that are located in a second management zone of the same electrical panel,
the connections being made via at least one junction zone separated from the power and management zones.

11. Process of electrically joining an equipment according to claim 10, wherein the electrical panel is located near the equipment.

12. Process of electrically joining at least two equipment in a building, according to which the equipment are joined to multiple electrical panels according to the process of claim 10.

13. Method of manufacturing an electrical panel to connect the equipment of an installation, the electrical panel comprising at least one power box, one management box, and one junction box, comprising the following steps:
(A) the technical information required for connecting the electrical panel to the installation is determined,
(B) the equipment to be connected to the electrical panel are identified and categorised by family according to a nomenclature of families, determined on the basis of the installation type, to establish a list of families of equipment to be joined,
(C) the management functions (or purposes) of the equipment associated with each family from the list of families are identified to establish a list of functions to be joined,
(D) each management function is set up in an organised way in a management box of the electrical panel,
(E) the components for transporting electricity to the equipment required for connecting the equipment are determined and installed in a power box of the electrical panel,
(F) the adapted electrical connections between the management functions, the components for transporting electricity to the equipment and the junction ports included in the junction box(es) are established.

14. Method of manufacturing an electrical panel according to claim 13, according to which the management functions of the equipment associated with each family from the list of families are identified according to a nomenclature of functions determined for each family, to establish a list of functions to be joined.

15. Method of manufacturing an electrical panel according to one of claim 13 or 14, wherein each management function is set up in an organised way in a management box of the electrical panel such that it forms modules, each module corresponding to a function of a family.
